(19) United States
(12) Patent Application Publication
(10) Pub. No.: US 2008/0180213 A1
(43) Pub. Date: Jul. 31, 2008

(54) Digital Intercom Based Data Management System

(76) Inventor: Stephen W. Flax, Milwaukee, WI (US)

Correspondence Address: WHYTE HIRSCHBOECK DUDEK S.C., 33 East Main Street, Suite 300, Madison, WI, 53703-4655, US

(21) Appl. No.: 11/936,347

(22) Filed: Nov. 7, 2007

Related U.S. Application Data
(60) Provisional application No. 60/871,344, filed on Dec. 21, 2006.
(60) Provisional application No. 60/871,356, filed on Dec. 21, 2006.
(60) Provisional application No. 60/864,628, filed on Nov. 7, 2006.
(60) Provisional application No. 60/864,626, filed on Nov. 7, 2006.

(51) Int. Cl. G10L 17/00

(52) U.S. Cl. 340/5.84

(57) ABSTRACT

A digital intercom based data management system and methods are provided. In at least one embodiment of the invention the system includes a digital intercom, a processor and a mobile RFID device. The system can be implemented within a healthcare facility and enables efficient and accurate management of data in a health care facility.

### CROSS-REFERENCE TO RELATED APPLICATIONS

This application claims priority to U.S. Provisional Application Ser. No. 60/871,344, filed Dec. 21, 2006, U.S. Provisional Application Ser. No. 60/871,356, filed Dec. 21, 2006, U.S. Provisional Application Ser. No. 60/864,628, filed Nov. 7, 2006, U.S. Provisional Application Ser. No. 60/864,626, filed Nov. 7, 2006, and co-pending Non-Provisional Patent Application titled “Bi-modal Remote Identification System”, attorney docket number FT-34170, and filed on Nov. 7, 2007, each application is fully incorporated by reference herein.

### STATEMENT REGARDING FEDERALLY SPONSORED RESEARCH OR DEVELOPMENT

The U.S. Government has certain rights in this invention as provided for by the terms of Grant No. R44 AG019528 awarded by the National Institutes of Health.

### FIELD OF THE INVENTION

Embodiments of the present invention generally relate to data input and management systems. More specifically embodiments of the present invention relate to digital data management through use of digital intercoms and speech recognition methods.

### BACKGROUND OF THE INVENTION

Insuring the timely, complete and accurate entry of patient data within a health care facility is of critical importance. The appropriate management of patient data directly impacts patient care, clinical compliance, and safety. The information is also important to the facility for being able to obtain appropriate reimbursements and for being able to avoid liability issues. In primary care facilities, such as hospitals with highly trained personnel, there are usually stringent procedures in place regarding how and where the patient data is collected and how it is entered into the medical record or database. Often, data is entered directly into a PDA or small laptop computer carried by individual healthcare workers. These devices are then used to download and synchronize their data with the main database. In many situations, patients are directly monitored in their rooms with sophisticated equipment which is then directly tied into the main medical database. When these systems work effectively, they allow appropriate healthcare workers to easily obtain a snapshot of a patient's status. While these systems are extremely effective, they do have drawbacks such as being expensive to implement and they require a dedicated and skilled staff to make them work successfully.

Speech recognition technology exists in many different applications. However, speech recognition equipment is usually located at the site where it will be utilized. For example, if speech recognition dictation software is installed on a computer, then the system user would typically sit at that computer terminal and directly dictate into a microphone connected to that computer, thus insuring the best audio quality available for signal processing. Another factor to consider with speech recognition equipment is the overall recognition accuracy rate. While for many applications, the statistical error rate for word recognition might be acceptable, the absolute error rate is still high. For example, with general dictation software the overall error rates can range from 5 to 15 percent. For limited vocabulary systems with non-speaker dependent capabilities, the accuracy can approach the 97 percent level. Similarly, for speaker dependent systems (the system is trained to a specific speaker's voice) the accuracy rate can approach the 99 percent level. While this appears to be very good, in reality a one percent error rate is still unacceptable for many applications. For example, a data entry scheme with a one percent error rate as applied to a medical database would be very unacceptable.

It would be advantageous to provide a method for high accuracy speech recognition through use of a digital intercom and novel radio frequency identification (RFID) that manages patient and employee data within a healthcare facility.

### BRIEF DESCRIPTION OF THE DRAWINGS

FIG. 1 is a block diagram of the digital intercom based data management system in accordance with at least one embodiment of the present invention.

FIG. 2 is block diagram of an exemplary intercom in accordance with at least one embodiment of the present invention.

FIG. 3 is a flow chart for a method of recording data through the digital intercom based data management system in accordance with at least one embodiment of the present invention.

FIG. 4 is a flow chart of an exemplary method of incorporating an audio menu into the digital intercom based data management system in accordance with at least one embodiment of the present invention.

FIG. 5 is a flow chart of an exemplary method of recording and associating patient data of the digital intercom based data management system in accordance with at least one embodiment of the present invention.

FIG. 6 is a flow chart of an exemplary method of continuous recursive speech training of the digital intercom based data management system in accordance with at least one embodiment of the present invention.

### DETAILED DESCRIPTION OF THE PREFERRED EMBODIMENT

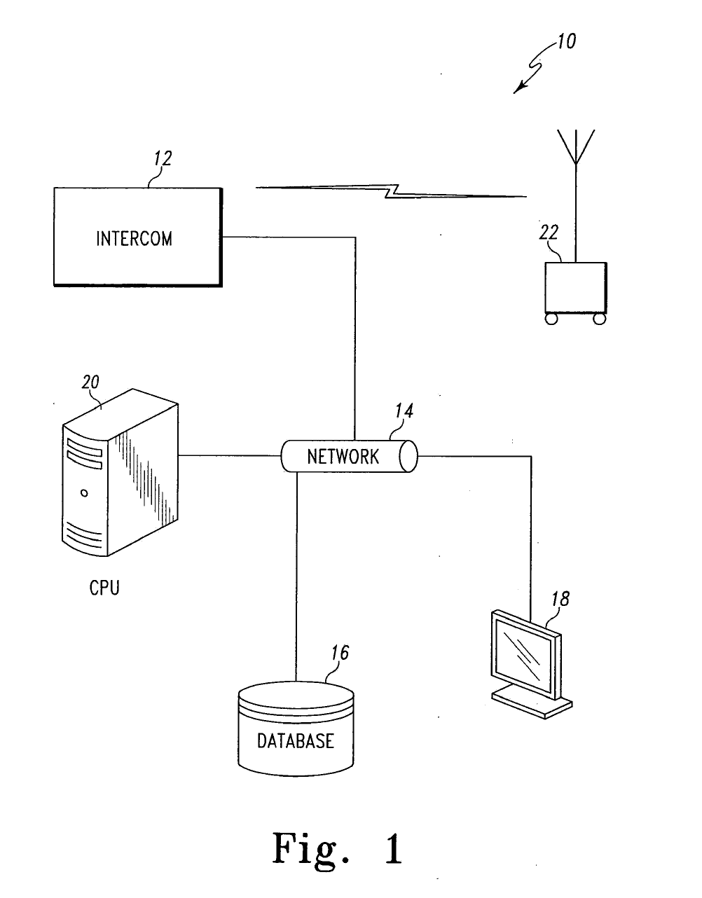

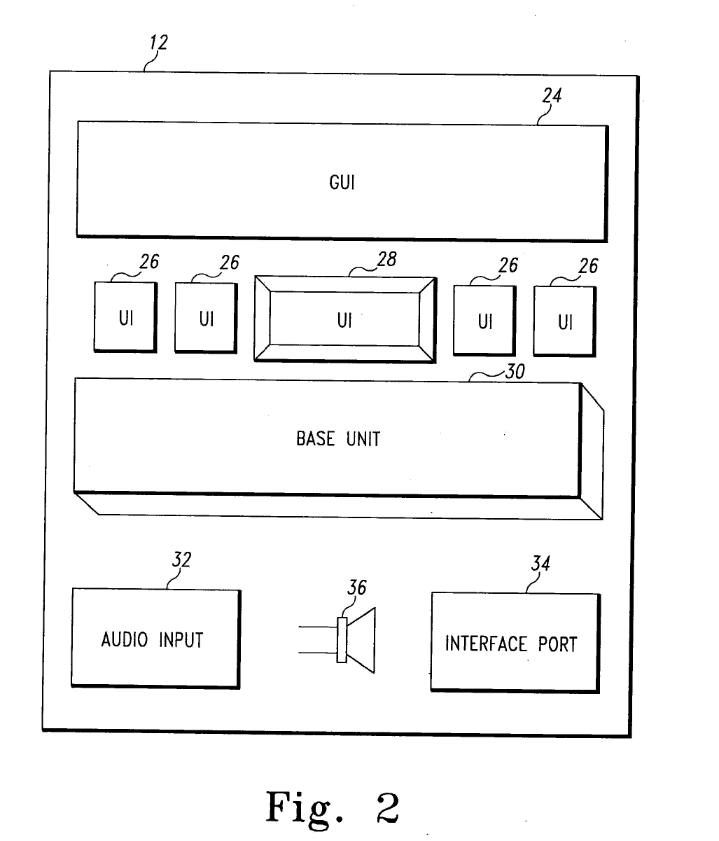

Referring to FIGS. 1-2 an illustrative example of a digital intercom based management system 10 in accordance with at least one embodiment of the present invention is shown. A digital intercom based data management system 10 includes a digital intercom 12, a computer network 14, a database 16 connected to the network 14, a graphical user interface (GUI) 18, a central processing unit (CPU) 20 and a mobile radio frequency identification (RFID) tag 22. The digital intercom is connected to the computer network 14 through an Ethernet or substantially equivalent network technology. Alternatively, the network 14 can be substantially different from an Ethernet either presently known or later developed. A database 16 stores patient data files, caregiver data files, and speech recognition library templates associated with each caregiver. The database 16 can be a relational database and also includes an integrated memory storage device for storing patient and system 10 data. The user interface 18 is connected to the network 14 and allows for caregivers to locally access patient data files. The CPU 20 processes the data and information stored within the database 16 as well as data retrieved from the intercom 12 and the RFID tag 22. The system 10 incorporates the bi-modal remote identification system and methods as described within the co-pending patent applications titled “Bi-modal Remote Identification Device”, U.S. Ser. No. 60/864,628, filed on Nov. 7, 2006, and U.S. Ser. No. 60/871,344, filed Dec. 21, 2006. The intercom functions as the base unit RF receiver and ultrasound transmitter described within the co-pending patent application.

A block diagram of the digital intercom is shown in FIG. 2. The intercom 12 includes a GUI 24, tactile user interfaces 26, 28, a base unit 30, audio input receiver 32, interface port 34, and a speaker 36. The GUI 24 displays system 10 and patient-specific data thereby enabling a healthcare facility caregiver to access information related to a patient or the health care facility. The GUI 24 can display patient health information, updates related to healthcare, and facility alerts, among other emergency and non-emergency information. The tactile user interfaces 26, 28 are buttons, touch screen, or substantially equivalent device for entering data into the intercom 12. The base unit 30 includes a radio frequency (RF) transceiver and an ultrasound transmitter. The audio input receiver 32 recognizes audio data input, such as caregiver speech input, and enters the audio data into the database 16. Interface port 34 enables peripheral medical and health related devices to sync with the intercom 12 and download pertinent health and medical data. By example, the interface port 34 is an infrared input/output device that communicates with a patient care monitoring device such as a blood glucose monitor, an electronic thermometer, or an electric weight scale. The data from the monitoring device is input into the intercom 12 and saved on the memory storage device 16 through the port 34. The port 34 can also be a male/female electrical port. The speaker 36 converts data or system 10 requests from a digital form to an auditory form available for caregivers and patients to hear.

Privacy and security are important concerns for patients or residents, which are maintained by the system 10, which can provide another level of security beyond that of the RFID alone. A biometric technique known as speaker verification is incorporated into the system, insuring additional system and data security. Specifically, every system user chooses a private pass-phrase, for example ‘the dog barked,’ that is known only by that individual. Then, that individual “trains” the system by creating a unique template for the chosen pass-phrase, based on their own individual speech pattern. Then if an added level of security is warranted, the user begins a session by speaking their unique pass-phrase. The system, using the RFID information, accesses the pass-phrase template for that individual and then tests it for a match. If there is a match, the person could then proceed with the data entry process.

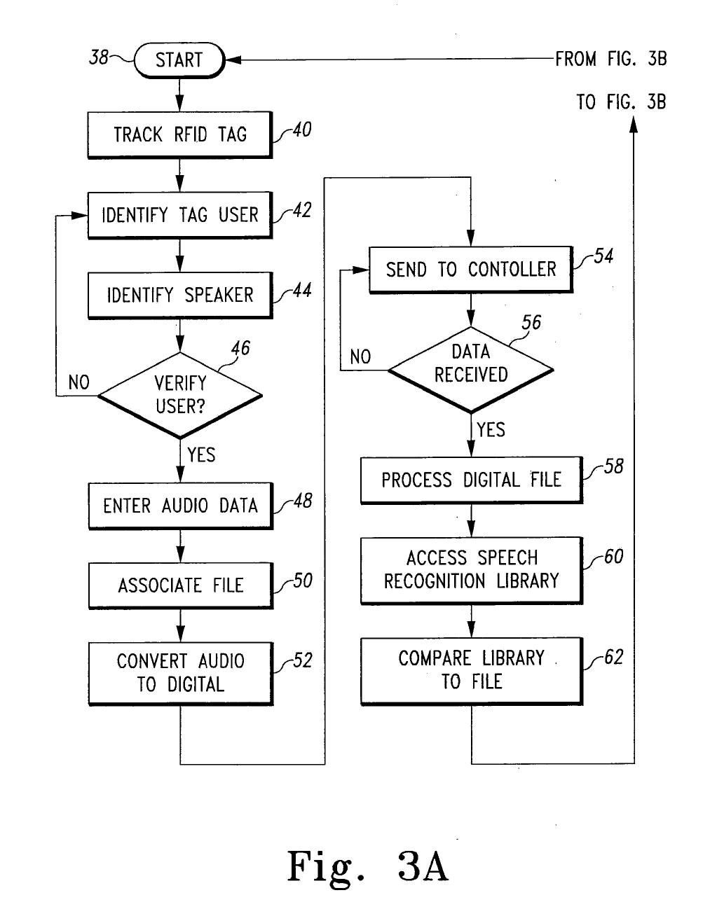

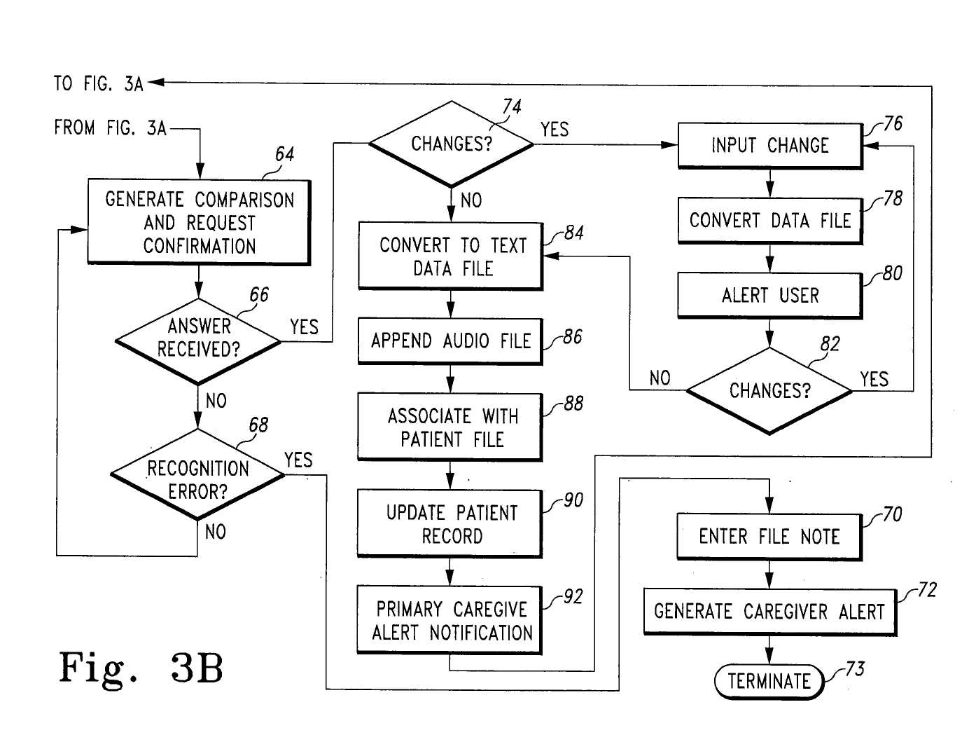

Referring to FIG. 3, system 10 is initiated at step 38. A caregiver tag is recognized in the vicinity of a patient tag at step 40. The patient and caregiver are identified at step 42 and an intercom 12 user is identified at step 44. The speaker verification occurs at step 46. The verification process includes a request for a pass phrase unique to the identified speaker, alternatively a pass phrase is not required. If the speaker is not verified then step 42 is repeated, otherwise audio information is received by the intercom at step 48. A patient data file association is made based upon the most proximal patient at step 50. Audio input data is converted to digital data files at step 52 and sent to the controller 20 at step 54. Receipt of the converted data by the controller 20 is determined at step 56. If the data is not received then the step 54 is repeated, otherwise the controller 20 processes the converted digital audio data file at step 58. The speech recognition library associated with the identified caregiver is accessed from the database 16 at step 60. The speech recognition library is compared to the converted digital audio data file at step 62. The controller 20 requests the caregiver to confirm entry of and specifics for the converted digital audio data file at step 64. A determination is made as to whether a response to the confirmation request at step 66. If a response was not received then a determination is made if a recognition error has occurred at step 68. If a recognition error has occurred then a note is generated and saved in the patient's file at step 70 and the caregiver is alerted at step 72 and terminated at step 73.

If a recognition error did not occur at step 68 then step 64 is repeated. If an answer was received at step 66 then a determination as to any changes that need to be made to the digital data file occurs at step 74. If changes are necessary the caregiver inputs the data file changes at step 76 and the file is converted at step 78. The intercom generates an alert for the caregiver indicating that a change has been made at step 80. A determination as to any changes that need to be made to the digital data file occurs at step 82. If changes are necessary then step 76 is repeated, otherwise the digital data file is converted to a text format and saved in the patient's healthcare file at step 84. The converted digital data file is appended to the data file entry at step 86 and can be accessed by any authorized caregiver. Identification information is associated at step 88 with the file saved at step 84. The identification information includes a patient ID, a caregiver ID, the room number where the intercom 12 was accessed, and the time at which the data was entered. The patient's health record file is updated at step 90 and the primary caregiver is alerted at step 92, which then results in a repeat of step 38.

The system 10 can identify various health care provider and patient interactions. When a health care provider is within a predefined proximity range of a particular patient the CPU 20 accesses the patient data and identifies any scheduled health care activities which are past due or coming due for the particular patient. The health care activities data is communicated to the health care provider through the intercom, which can transmit it in an audio and/or visual manner. By example, if a patient's vital signs are required to be recorded every 2 hours, when a health care provider is identified as being within the patient's room at a 2 hour interval it will prompt the provider to obtain the patient's vital data. The vital data is then input into the system through the intercom 12. Inputting the data can be performed by the provider speaking the data or manually entering it into the intercom through an interface such as a keyboard. Alternatively, the device (not shown) measuring the patient vital data can be connected to the intercom 12 or directly to the computer network through a hard wire and/or wireless data connection, which allows for automatic downloading of the acquired patient data. The CPU 20 can also prompt a health care provider visiting with a first patient in a separate room within a health care facility, that a second patient requires a particular health care activity. The health care activity can be any health care related interaction that takes place within a health care facility, whether it is a hospital, nursing home, extended care facility or any other health care related facility. Alternatively, the provider prompt relating to the second patient can be based upon proximity of the health care provider to the second patient's room, such as visiting an adjacent patient room. The prompts can be distinct for different types of health care providers. By example, the system prompt can be programmed to prompt a doctor to perform a particular health care activity, whereas a nurse or other health care provider can be prompted to perform a separate health care related activity.

The system 10 incorporates an audio menu to enhance the level of speech recognition accuracy for the system 10. For example, the database 16 contains a master schedule for the care of patients or residents. When the system 10 detects that a given care worker is in the presence of a given resident, as based on the detection of both of their RFIDs, the system 10 determines if a scheduled event should be performed for that resident. Instructions to the care worker are conveniently delivered verbally. Consequently, instructions to the caregiver can be delivered by the system 10 based on pre-recorded voice clips pertaining to the task at hand. After the controller 20 selects the appropriate wave clip, it can then be played through the intercom and directed to the caregiver. Alternatively, appropriate text messages are stored in the database in the form of physician orders. Using text-to-speech software, the text messages are read and transmitted appropriately over the intercom 12.

The GUI 18 is connected to the computer network and provided for accessing and manipulating asset data. The GUI 18 provides a color coding scheme based upon the current time and task state for a health care patient. Various health care activities (tasks) can be associated with each patient in a health care facility. The color coding scheme provides an effective overview of the schedule status for a patient at a glance, making it easier for providers to administer health care activities to patients. Data relating to “on time” activities, early, late completed, in process, etc. types of activities are presented in a color coded ergonomic progression. Scheduled activities and performed activities are graphically separated for identifying tasks that have been performed and tasks that need to be performed, at the present or in the future.

The GUI 18 can provide a daily, weekly, and/or monthly schedule for each health care facility patient. Various data can be accessed from the GUI 18, including patient health care tasks, daily schedule data for each patient, patient medical history data, patient data, intercom activity, and alternative health care related information. The GUI 18 can alternatively be wirelessly connected to the system 10, thereby allowing health care providers to view and alter the data from any location.

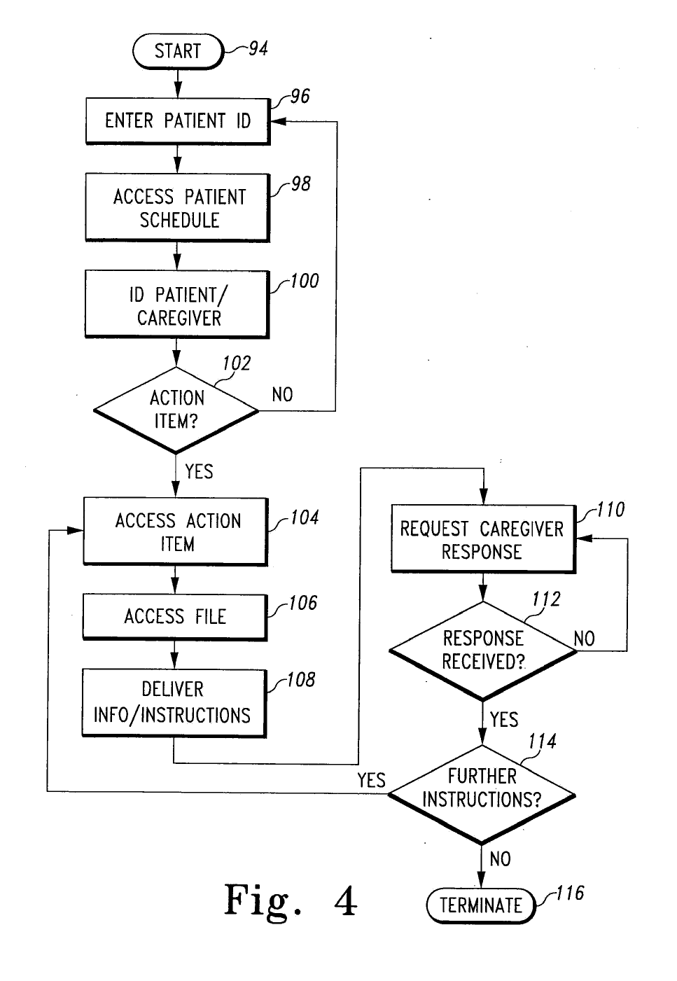

Referring to FIG. 4 the controller activates an audio menu at step 94. Patient information and data is entered at step 96 and the patient's schedule and data file is accessed at step 98. The patient and caregiver most proximal to the intercom 12 are identified at step 100. A patient action item determination is made at step 102. If there is not an action item then step 96 is repeated, otherwise the action item is accessed at step 104. The textual action item is converted to a digital data file at step 106. The action item audio file is delivered to the intercom and the speaker 36 is actuated at step 108. A caregiver response request is generated at step 110. Receipt of the response is determined at step 112. If a response is not received then step 110 is repeated, otherwise a further action item determination is made at step 114. If there is another action item then step 104 is repeated, otherwise the sequence terminates at step 116.

An important feature of the system 10 is the way in which the data associated with the caregiver's response is recorded and confirmed. As the verbal templates for each individual are grouped by their corresponding RFIDs, there are also limited subsets of templates associated with every instruction or question transmitted by the system 10. In this case, the limited subsets are related to the possible range of responses that the system 10 expects in reply to a given query. For example, if a question is asked that has an expectation of a “Yes” or “No” response, the word templates used in the interpretation of the response are limited to only that individual's “Yes” and “No” templates. By looking for only one of two responses from the template list, instead of having to search through a complete list of responses, will greatly enhance the statistics of obtaining a correct response. This is the verbal equivalent of how data is entered using menu driven computer touch screens. With a touch screen, a question is presented on a screen with appropriate boxes representing the only possible responses. Depending on the given response, a new menu page with different questions and/or responses is presented. Response errors are minimized since there are so few possible responses associated with each question or instruction. Our verbal menu is equivalent to the touch screen concept, except that responding to audio queries with verbal responses is much easier and more natural than using computer touch screens. By example, if one individual is communicating with another individual in a noisy environment where conversation is difficult, communication errors or “misunderstandings” can occur between the two people. However, if one person knows, in advance, that the other person is only going to be saying “Yes” or “No”, then there is much less chance of having a miscommunication.

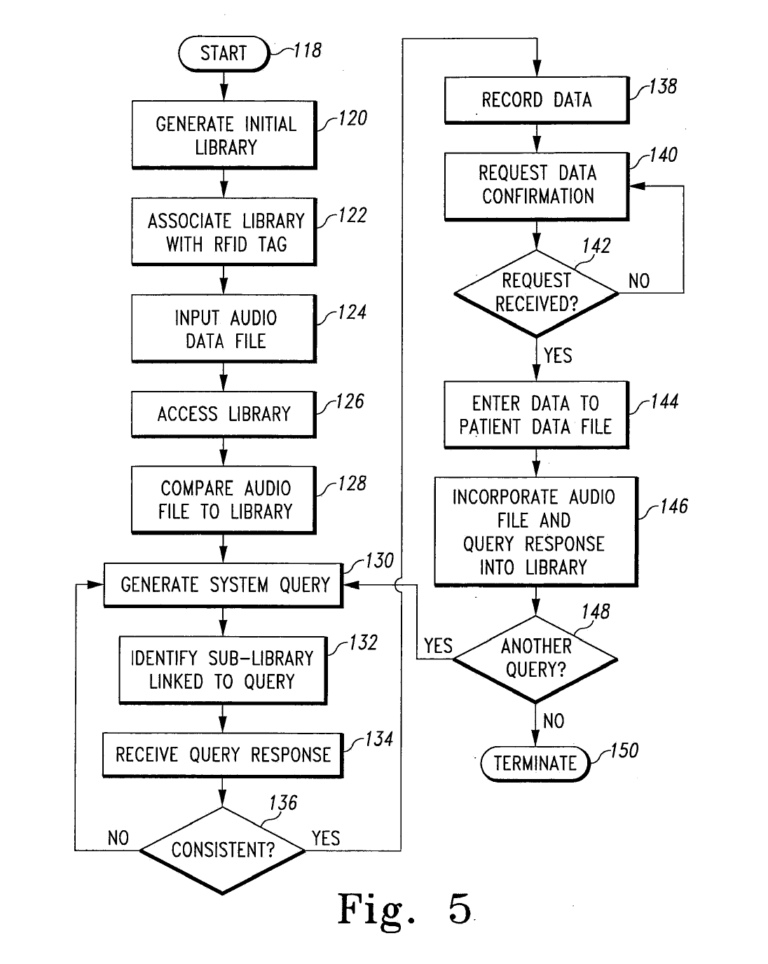

Referring to FIG. 5, a sequence for recording and confirming a caregiver's input is initiated at step 118. The initial speech library template is generated at step 120. The library is generated by a predefined program for which the caregiver must respond to various questions and provide speech identification. The library is associated with a RFID device 22 and ultimately a caregiver at step 122. A caregiver entered speech file containing patient data is entered at step 124 and the identified caregiver's library file is accessed at step 126. The speech file is compared to the library at step 128 and the controller 20 generates a patient data query at step 130. A sub-library template is linked to the query at step 132 and the response is received at step 134. A determination of consistency between the sub-library template and the available responses is made at step 136. If the response is not consistent with the available responses then step 130 is repeated. If the response is consistent then the response data is recorded at step 138. A confirmation request is generated at step 140 and a determination as to whether the request was received is made at step 142. If the response was not received then step 140 is repeated, otherwise the data is entered into the patient data file at step 144. The controller 20 incorporates the caregiver audio file and query response into the library at step 146, which increases the accuracy of correct responses for future intercom 12 uses. Step 148 determines if there is another query. If there is another query then step 130 is repeated, otherwise the sequence terminates at step 150.

The system 10 incorporates continuous recursive training technology for the speech recognition engine. Each user must go through a training session in order for the system 10 to “learn” the individual's speech patterns and to generate their unique speech templates or libraries. When the user speaks into the system, the speech pattern is compared to the appropriate series of speech templates and a statistical decision is made as to which word was spoken. However, that most recently spoken word can also be used to generate a new template. Then statistical information from the new template can be used to modify or adjust the stored template for that word. Consequently, over time, the word template will slowly be improved and will approach a best fit for that word.

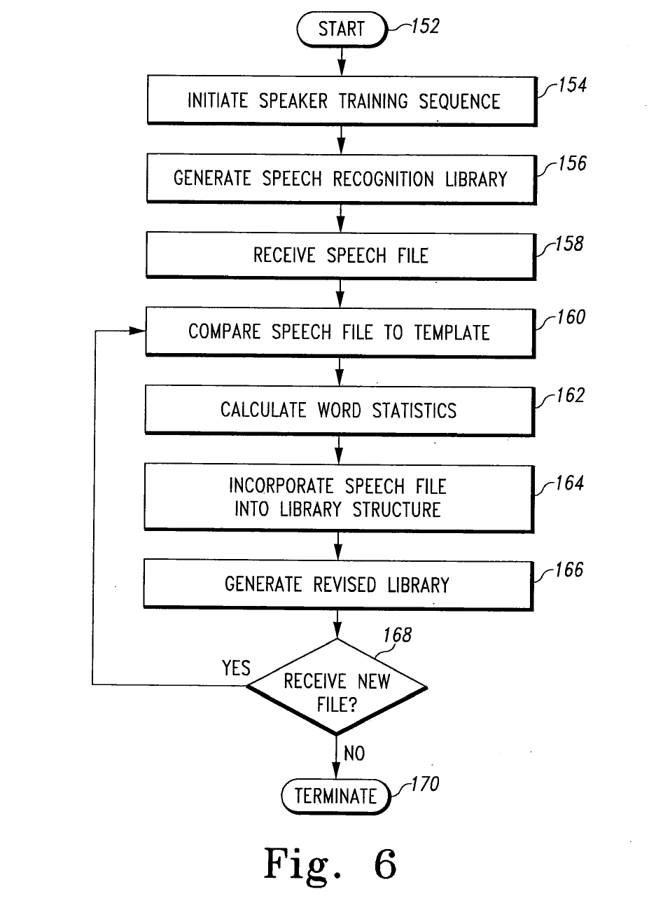

Referring to FIG. 6, a recursive training sequence is initiated at step 152 followed by a speaker training sequence at step 154. A speech recognition library is generated for the caregiver at step 156. The intercom 12 receives and stores a speech input file at step 158. The speech file is compared to the template at step 160, which is followed by the calculation of speech recognition statistics at step 162. The speech file incorporation is calculated at step 164 and a revised speech library template for the caregiver is generated at step 166. Receipt of new speech data file is determined at step 168. If a new speech data file is received then step 160 is repeated, otherwise the sequence is terminated at step 170. The speech data file is the recorded audio file received by the intercom 12 that results from a caregiver entering speech audio data into the intercom 12.

Once the response has been spoken into the intercom 12 and then compared to appropriate response templates, the system 10 plays back an appropriate wave clip to confirm what the system 10 had just interpreted. By example, the “Yes” or “No” answer scenario is applicable. If the respondent answers “Yes” and the system then interprets the response as “Yes”, the system 10 then plays back a message such as, “You answered ‘Yes’, is that correct?”

The operator responds with “Correct” or “No.” At that point, if the answer is “Correct” the system 10 enters the data into the data base. If the answer is “No” then no data is recorded and the system would repeat the original question and then try again.

All raw audio data passing through the intercom 12 will be recorded to a hard disk 16. For example, if the digitized audio information is sampled at 8 KHz, then a single 60 G Byte hard drive could store all audio communications for more than a year, assuming a 20% usage duty cycle for the intercom. Given the use of the RFIDs, each raw recorded response would also be tagged with the room number, the ID numbers of those individuals present in the room and the time that the response was received. In the event that there is a question concerning a given event, it will be possible to reconstruct that event by retrieving the information based on time, date, and/or the individuals involved.

While it is believed that all of the prior steps taken to improve the speech recognition capabilities of the system will make this situation rare, it is still important to have a fall back position if the system does not recognize the caregiver's response. Consequently, if a data recognition error is detected, the system will repeat the query one time. However, if the second response is also incorrect, then a flag will be generated in the data base and the system continues. Because of the fact that all of the raw data is recorded, it is a simple matter for a human operator to listen to all of the flagged responses and then manually enter the appropriate response at a later time.

It is also feasible to enter or store information that is not actually part of the database itself. For example, if it is desired to enter data into the system other than that relating to the audio menu data, then raw messages can still be inserted into the patient's or resident's record. Consequently, if a care worker enters data into the patient's or resident's record, the care worker will have the ability to push a button on the unit labeled “Notes.” The “notes” entry attaches a special flag to the file indicating that this is a note for the file of the resident whose RFID is present. Consequently, any physician or care supervisor observing the data screen, can observe flags attached to the names of those residents who had recorded notes. By clicking on a given flag, the note is played back to the caregiver. This is analogous to having a care worker record a written note into a patient's file. For example, a care worker goes into patient's room and notices that the resident has a large black and blue area on their arm, possibly resulting from a fall. The care worker should make a note of this in the resident's record and should notify a supervisor of the observation. Unfortunately, busy care workers do not always take the time or effort to record all of these observations in the resident's record and may forget to notify the supervisor of the observation. However, if the care worker only has to simply press a button and then verbally state that “Mr. Smith has a 4 cm bruise on his arm” it is much more likely to be reported. At that point, pressing the button on the unit automatically notifies the supervisor that a note had been recorded. In addition to the recorded note, the care worker's and the resident's RFIDs are recorded along with the time of the occurrence. When the supervisor wants to check the notes, they would simply listen to the recorded notes instead of reading file notes.

The system 10 digitally modifies audio signals presented to individual residents in order to optimize their ability to listen to the messages. That is, often the elderly do not have normal hearing abilities. For any given individual, these deficiencies are often corrected by appropriately modifying the audio signal that they are listening to, in order to correct for their deficiency. This is routinely done with customized hearing aids. In our case, the system recognizes the caregiver based on the RFID signals. The controller 20 is capable of individually modifying the transmitted audio signal to the given individual in order to improve their ability to understand the message.

In an alternative embodiment, the database associated with the system conforms to the guidelines set forth for SNF and CBRF care facilities.

In yet another alternative embodiment, the system 10 can be used to locate patients and providers for the purposes of verbally communicating with them. Once a particular individual's location is identified, the intercom closest to the individual can be activated and two-way communication with another individual can be established. Data relating to the time and location of patients and providers can also be tracked and recorded for later use.

Although the invention has been described in detail with reference to preferred embodiments, variations and modifications exist within the scope and spirit of the invention as described and defined in the following claims.

What is claimed is:

1. A digital intercom based data management system comprising
a digital intercom connected to a computer network, the intercom comprising an interface for receiving and transmitting information, a ultrasound transmitter and a radio frequency (RF) receiver;
a central processing unit (CPU) connected to the computer network, the CPU processes electronic information received from the intercom and transmits electronic information to the intercom, wherein the intercom is capable of converting electronic files into audio and graphical data, the files are saved to a database connected to the network; and
a mobile radio frequency identification device (RFID) comprising an RF transmitter and an ultrasound receiver, the RFID capable of exchanging data with the intercom, wherein the CPU recognizes an RFID and accesses files from the database associated with the RFID.

2. The system according to claim 1, wherein a plurality of unique RF devices are associated with a plurality of assets.

3. The system according to claim 2, wherein the assets are selected from the group consisting of health care workers, health care patients, health care facility visitors, and health care devices.

4. The system according to claim 1, wherein the intercom and RFID exchanges signals, the CPU processes the RFID and intercom data, accesses information associated with a particular asset from the database, and transmits data to the intercom, wherein the intercom transmits data to an asset associated with an RFID.

5. The system according to claim 4, wherein the data is transmitted to a first asset, the data being associated with the health care of a second asset, wherein the first asset is a health care provider and the second asset is a patient.

6. The system according to claim 5, wherein the data transmitted to the first asset is selected from the group consisting of scheduled health care maintenance, medication prompts, patient vital sign request, unscheduled health care maintenance, patient medical history data, patient medical data, and health care provider data.

7. The system according to claim 2 further comprising an administrator graphical user interface (GUI) for accessing and manipulating patient and health care provider data.

8. The system according to claim 7 wherein the patient data is selected from the group consisting of medical data, health care treatment data, medical history data, and healthcare provider data.

9. The system according to claim 7 wherein the GUI displays a color-coded patient data scheme, wherein data associated with scheduled health care activities are associated with a different color than data associated with health care activities already performed.

10. The system according to claim 9, wherein the color-coded scheme provides a current graphical state of the health care associated with a patient.

11. A method for dynamically accessing patient data in a health care facility comprising the following steps:
identifying a first RFID device associated with a health care facility patient and identifying a second RFID device associated with health care facility provider, wherein the patient and the provider are located within a predefined range of a digital intercom device comprising an ultrasound transmitter and an RF receiver, the intercom device being connected to a computer network;
accessing data files associated with the health care patient, the data files saved in a database connected to the computer network,
transmitting the patient data files to the intercom device, wherein the data files are accessible to the health care provider for use in providing health care related services to the patient.

12. The method according to claim 11, wherein the RFID transmits a first RF signal and receives an ultrasound signal from the intercom device in response to the first RF signal, a second RF signal being sent to the intercom device in response to the ultrasound signal, wherein the RF signal contains data associated with the patient.

13. The method according to claim 11 wherein the health care patient data files include historical medical data and scheduled health care activities associated with the patient.

14. The method according to claim 11 further comprising the following step:
saving data to the database, the data being received by the intercom device and transmitted electronically to the database over the computer network.

15. The method according to claim 14 wherein the data is healthcare related data specific to the patient.

16. The method according to claim 15 wherein files associated with the patient are updated, wherein scheduled health care activities and completed health care activities are logically separated.

17. The method according to claim 16 further comprising the following step:
displaying patient data files on a graphical user interface connected to the computer network, patient data being graphically displayed within a color-coded scheme.

18. A health care facility digital intercom system comprising:
a digital intercom device located within a plurality of patient rooms within a health care facility, the intercom comprising an ultrasound transmitter and a radio frequency (RF) receiver;
a central processing unit (CPU) connected to a computer network, the CPU processes data received from the intercom and controls transmission of data to the intercom; and
a first mobile radio frequency identification device (RFID) associated with a health care patient and a second mobile RFID associated with a health care provider, the RFID comprising an RF transmitter and an ultrasound receiver.

19. The system according to claim 18, wherein the CPU accesses patient data based upon a wireless data exchange between the intercom and the patient RFID.

20. The system according to claim 18, wherein patient data is saved in a database connected to the computer network.

21. The system according to claim 19, wherein the intercom provides health care activity data associated with the patient based upon a wireless exchange between the intercom and the health care provider RFID.

22. The system according to claim 21, wherein event data is associated with each patient data entry, the event data is selected from the group consisting of time, place, event logistics, and individuals involved with the event.
